(19) United States
(12) Patent Application Publication
(10) Pub. No.: US 2017/0372681 A1
(43) Pub. Date: Dec. 28, 2017

(54) METHOD, APPARATUS, AND STORAGE MEDIUM

(71) Applicant: FUJITSU LIMITED, Kawasaki-shi (JP)

(72) Inventors: Tomoharu Imai, Kawasaki (JP); Kazuki Matsui, Kawasaki (JP)

(73) Assignee: FUJITSU LIMITED, Kawasaki-shi (JP)

(21) Appl. No.: 15/496,547

(22) Filed: Apr. 25, 2017

(30) Foreign Application Priority Data
Jun. 28, 2016 (JP) 2016-127941

(51) Int. Cl. G09G 5/34; G06F 3/14; G09G 5/00

(52) U.S. Cl. CPC G09G 5/34; G09G 5/005; G06F 3/1454; G09G 2370/022

(57) ABSTRACT

A method includes: first setting a display range of image data stored in a memory and to be displayed in a display of a terminal device, in accordance with a scroll amount determined based on operational information acquired from the terminal device; measuring a first frequency of update at which a region within the image data is updated in the display range; and second setting, by a processor, based on the first frequency, a second frequency of capture at which partial image data of image data corresponding to the region is captured from the memory when the region is changed from an inside of the display range to an outside of the display range by changing of the display range.

### CROSS-REFERENCE TO RELATED APPLICATION

This application is based upon and claims the benefit of priority of the prior Japanese Patent Application No. 2016-127941, filed on Jun. 28, 2016, the entire contents of which are incorporated herein by reference.

### FIELD

The embodiments discussed herein are related to a method, an apparatus, and a storage medium.

### BACKGROUND

Due to increases in the performance of mobile terminals such as mobile phone devices including smartphones, personal handy-phone systems (PHSs), slate terminals, and tablet terminals and increases in the speeds of mobile communication networks, the use of mobile terminals for business is increasing. For example, the number of cases where organizations such as companies lend out mobile terminals to employees and cases where smartphones owned by individuals are used as Bring Your Own Device (BYOD) for business is increasing.

When a mobile terminal is used for business, a mobile solution by a screen transfer scheme in which data does not remain in a client terminal is paid attention. Specifically, it is sufficient if the client terminal has a function of receiving and displaying image data. Thus, the screen transfer scheme is also referred to as thin client scheme.

In the thin client scheme, the Remote Desktop Protocol (RDP) or the like is used to transfer operational information from the client terminal to a server device and transfer screen information from the server device to the client terminal. The server device narrows image data down to an updated portion indicating differences between data on a screen before the update of the screen and data on the screen after the update of the screen and transfers the image data portion to the client terminal, instead of transferring the image data on the overall screen.

For example, when a business screen provided by a business application or the like is to be displayed, a function of hooking a draw command to be issued by the business application to an operating system (OS) upon the update of the business screen is used. After image data on the updated portion of the business screen is generated in accordance with the draw command hooked by the aforementioned function, the image data on the updated portion is transferred from the server device to the client terminal. By using this OS support, a process of chronologically comparing business screens updated by the business application and detecting a difference for screen transfer is omitted. Due to the omission of the process, a process load is reduced.

As an example of related art, Japanese Laid-open Patent Publications Nos. 2014-207529 and 07-175617 are known.

### SUMMARY

According to an aspect of the invention, a method includes: first setting a display range of image data stored in a memory and to be displayed in a display of a terminal device, in accordance with a scroll amount determined based on operational information acquired from the terminal device; measuring a first frequency of update at which a region within the image data is updated in the display range; and second setting, by a processor, based on the first frequency, a second frequency of capture at which partial image data of image data corresponding to the region is captured from the memory when the region is changed from an inside of the display range to an outside of the display range by changing of the display range.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates functional configurations of devices included in a thin client system according to a first embodiment;

FIG. 2 illustrates an example of changes in visible and invisible regions;

FIG. 3 illustrates an example of changes in update maps;

FIG. 4 illustrates an example of changes in the visible and invisible regions;

FIG. 5 illustrates an example of changes in the update maps;

FIG. 6 is a flowchart indicating a procedure for a process of transmitting image data according to the first embodiment;

FIG. 7 is a flowchart indicating a procedure for a process of notifying of capture settings according to the first embodiment; and

FIG. 8 illustrates an example of a hardware configuration of a computer configured to execute a screen transfer program according to the first embodiment and a second embodiment.

### DESCRIPTION OF EMBODIMENTS

In the aforementioned technique, the performance of a response to a scroll operation may be reduced.

The size of a screen displayed in a mobile terminal depends on the resolution of a display included in the mobile terminal. Thus, the size of the business screen provided by the business application or the like may exceed a display range in which the mobile terminal is able to display image data in the display included in the mobile terminal. However, even if the aforementioned OS support is used, only the draw command related to, an update within the display range of the mobile terminal is hooked. Thus, when the display range of the business screen is changed by a scroll operation, differential detection related to an updated portion included in the display range after the change, and image data transfer based on the differential detection, are collectively executed. As a result, the performance of a response to the scroll operation may be reduced.

According to an aspect, embodiments suppress a reduction in the performance of a response to a scroll operation.

Hereinafter, the embodiments of the present specification are described with reference to the accompanying drawings. The embodiments do not limit techniques disclosed herein. The embodiments may be combined without contradiction of details of processes.

### First Embodiment

System Configuration

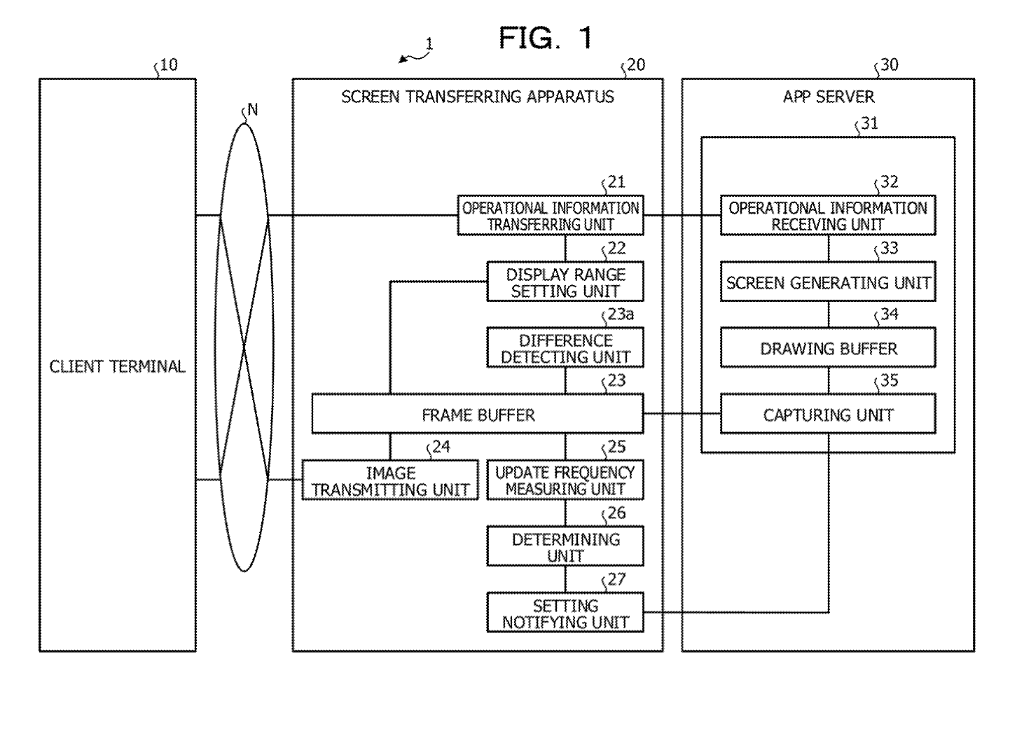

FIG. 1 illustrates functional configurations of devices included in a thin client system according to the first embodiment. The thin client system 1 illustrated in FIG. 1 is configured to provide a screen transfer service for transferring image data of a screen generated by an application (App) server 30 to a client terminal 10.

The following case is described below: image data of a business screen generated or updated by the App server 30 and to be provided for a personal computer (PC) is transferred by the aforementioned thin client scheme to the client terminal 10 as an example of the screen transfer service. In this case, the App server 30 is built as a business system, and the client terminal 10 is implemented as a mobile terminal.

As illustrated in FIG. 1, the thin client system 1 includes the client terminal 10, a screen transferring apparatus 20, and the App server 30. Although FIG. 1 illustrates the case where the single screen transferring apparatus 20 is coupled to the single client terminal 10, the single screen transferring apparatus 20 may be coupled to multiple client terminals 10.

The client terminal 10 and the screen transferring apparatus 20 are coupled to each other and communicate with each other via a network N. The network N is an arbitrary communication network. For example, if the client terminal 10 is implemented as a mobile terminal, the network N includes a mobile communication network supporting any generation's standard such as 3rd Generation (3G), 3.9G, 4th Generation (4G), or 5th Generation (5G) or includes a so-called mobile network.

The client terminal 10 is a computer that receives the provided screen transfer service.

As an example, a mobile phone device such as a mart hone, a PHS, or a mobile terminal such as a slate terminal or a tablet terminal is used as the client terminal 10. In this case, as the client terminal 10, a mobile terminal lent out by an organization such as a company or a mobile terminal for BYOD may be used. A case where the client terminal 10 is implemented as a mobile terminal is described below as an example. The client terminal 10, however, may be implemented as a desktop computer or a laptop computer.

The screen transferring apparatus 20 is a computer that provides the screen transfer service.

As an example, the screen transferring apparatus 20 is arranged as a gate device at a boundary between the App server 30 built as the business system and the network N. In this arrangement, the screen transferring apparatus 20 executes login authentication for accounts permitted access to the business system, and the screen transferring apparatus 20 provides the screen transfer service for sessions of the client terminal 10 which successfully logged in. Due to this implementation, the upgrade of an existing business system and the like are minimized. In addition, since the business screen is transferred as an image to the client terminal 10 by using the thin client scheme, business screens for types of OSs to be executed in the client terminal 10 may not be prepared.

The App server 30 is a server device that executes the business application.

As an example, the App server 30 may be implemented as a web server achieving the business system by causing a computer such as a server device to execute an existing business application provided as packaged software or online software or to execute, for example, an application program related to business of various types such as sales business and customer support business. The thin client system is exemplified as an onpremise thin client system, but is not limited to the onpremise thin client system. For example, the thin client system may be built as a cloud thin client system that provides functions related to the screen transfer service and the business system by outsourcing.

For example, the App server 30 generates HyperText Markup Language (HTML) statements of the business screen described in the HTML for the sessions of the client terminal 10 which successfully logged in, and the App server 30 executes a browser for browsing the HTML statements of the business screen. The App server 30 updates the business screen in accordance with operational information transferred via the screen transferring apparatus 20 from the client terminal 10. In coordination with the update of the business screen, the browser executed by the App server 30 generates image data of the business screen in a bitmap format by rendering the HTML statements of the business screen after the update. The image data, drawn by the browser, of the business screen is stored in a drawing buffer used by the browser as a work area.

As the browser, an expandable browser in which an application programming interface (API) for calling, from an external, a process of capturing the image data, stored in the drawing buffer, of the business screen is plugged is used. Since the API is used, the image data, stored in the drawing buffer, of the business screen is acquired by the screen transferring apparatus 20. Thus, by chronologically comparing the image data, acquired from the drawing buffer, of the business screen, a difference is detected from a portion located outside a display range that is included in the overall business screen and in which the client terminal 10 displays the image data in a display of the client terminal Hereinafter a portion that is included in the business screen and corresponds to the display range of the display included in the client terminal 10 is referred to as “visible region” in some cases, while a portion that is included in the business screen and corresponds to the outside of the display range of the display included in the client terminal 10 is referred to as “invisible region” in some cases.

As the frequency at which the image data of the business screen is acquired from the drawing buffer increases, the frequency at which the capturing and the difference detection are executed increases, and as a result, a process load increases. In addition, the frequency at which the image data is transferred between the screen transferring apparatus 20 and the App server 30 increases, and the amount of the transferred data increases. On the other hand, as the frequency at which the image data of the business screen is acquired from the drawing buffer is reduced, the difference between the time when a scroll operation is performed and the time when the business screen is captured from the drawing buffer increases. Thus, the probability at which the latest business screen is not displayed upon the scroll operation increases, and as a result, ease of operation is reduced by the mismatched business screen.

To avoid this, the screen transferring apparatus 20 according to the first embodiment captures image data related to the visible and invisible regions of the business screen from the drawing buffer, but frequencies at which image data related to all portions of the invisible region is acquired may not be set to be equal to each other, Specifically, the screen transferring apparatus 20 sets capture frequencies for portions that are included in the invisible region of the business screen and have history records indicating that the portions were within the visible region, in accordance with update frequencies measured when the portions were within the visible region. Thus, the size of a region, which is included in the business screen and on which the capturing is executed, is reduced, and the frequency at which the capturing is executed on the region is appropriately set. Thus, while the process load and the amount of data to be transferred may be suppressed, image data of the invisible region may be prepared for a change in the display range of the business screen. Accordingly, a reduction in the performance of a response to a scroll operation may be suppressed.

Configuration of Screen Transferring Apparatus

Next, a functional configuration of the screen transferring apparatus 20 according to the first embodiment is described. As illustrated in FIG. 1, the screen transferring apparatus 20 includes an operational information transferring unit 21, a display range setting unit 22, a frame buffer 23a, a difference detecting unit 23, an image transmitting unit 24, an update frequency measuring unit 25, a determining unit 26, and a setting notifying unit 27.

Processing units such as the operational information transferring unit 21, the display range setting unit 22, the difference detecting unit 23, the image transmitting unit 24, the update frequency measuring unit 25, the determining unit 26, and the setting notifying unit 27 are implemented as follows. The processing units are virtually achieved by causing a central processing unit (CPU) to load a screen transfer program as a process into a work area of a random access memory (RAM). The screen transfer program achieves the aforementioned screen transfer service. The RAM is implemented as a main storage device (not illustrated) and is a dynamic RAM (DRAM), a static RAM (SRAM), or the like.

The case where a main executor that executes the screen transfer program is the CPU is described above as an example. The screen transfer program, however, may not be executed by the CPU and may be executed by a processor of another type such as a micro processing unit (MPU). In addition, the aforementioned functional units may be achieved by hardware logic such as an application specific integrated circuit (ASIC) or a field programmable gate array (FPGA).

A semiconductor memory element such as a RAM may be implemented as a storage section such as the frame buffer 23a.

FIG. 1 selectively illustrates the minimal functional units that achieve the screen transfer service. The screen transferring apparatus 20 may include a certain functional unit other than the functional units illustrated in FIG. 1, while an existing computer includes the same functional unit as the certain functional unit. For example, the screen transferring apparatus 20 may include the same hardware as that included in the existing computer. For example, the screen transferring apparatus 20 may include a communication interface circuit such as a network interface card (NIC) or the like. In addition, the screen transferring apparatus 20 may include a processing unit virtually achieved by another program that is an OS, middleware, or the like and is the same as that to be executed in a processor included in the existing computer. Although the general-purpose functional unit included in the existing computer is not illustrated, it goes without saying that the functional unit is effective to achieve the screen transfer service and may be included in the screen transferring apparatus 20.

The operational information transferring unit 21 is a processing unit that transfers operational information.

As an example, every time the operational information transferring unit 21 receives operational information from the client terminal 10, the operational information transferring unit 21 transmits the received operational information to the App server 30. While the operational information transferring unit 21 transmits the received operational information to the App server 30 as described above, the operational information transferring unit 21 also outputs operational information of a predetermined type among the operational information received from the client terminal 10 to the display range setting unit 22, For example, if the client terminal 10 is implemented as a mobile terminal having a touch panel, examples of operations are tap, double tap, flick, swipe, long tap, drag, pinch-in, and pinch-out operations. In the first embodiment, the operational information transferring unit 21 also outputs, to the display range setting unit 22, operational information on swiping as an operation corresponding to a scroll operation described in the first embodiment.

The display range setting unit 22 is a processing unit that sets the display range of the business screen.

As an example, every time the operational information transferring unit 21 outputs operational information, the display range setting unit 22 shifts the display range of the business screen in accordance with the operational information. If the operational information transferring unit 21 does not output operational information, the display range setting unit 22 does not change the setting of the display range and maintains the setting of the display range. For example, if the client terminal 10 is implemented as a mobile terminal having a touch panel, the display range setting unit 22 may acquire, as operational information from the operational information transferring unit 21, the direction of swiping, the amount of the swiping, and the like. In this case, if the direction of the swiping is a horizontal direction or the display range of the business screen is scrolled in the horizontal direction, the display range setting unit 22 shifts the display range of the business screen toward the left or right side of the screen. If the direction of the swiping is a vertical direction or the display range of the business screen is scrolled in the vertical direction, the display range setting unit 22 shifts the display range of the business screen toward the upper or lower side of the screen. The amounts of the shifted range are determined based on the amounts of the swiping.

The difference detecting unit 23 is a processing unit that detects a difference between multiple image data items of the business screen.

As an example, the difference detecting unit 23 detects a difference between image data by comparing image data, transmitted by the App server 30, of the business screen with image data, stored in the frame buffer 23a, of the business screen. It is assumed that, if a frame number of the image data transmitted by the App server 30 is “N”, buffer management is executed to store, in the frame buffer 23a, image data having a frame number “N−1” and transmitted immediately before the transmission of the image data having the frame number “N”. Since the buffer management is executed, image data of the business screen is able to be chronologically compared.

Frequencies at which image data of all regions of the business screen is transmitted by the App server 30 to the screen transferring apparatus 20 may not be equal to each other. Specifically, the App server 30 transmits the image data to the screen transferring apparatus 20 by using the API for calling, from an external, the process of capturing the image data of the business screen stored in the drawing buffer of the aforementioned expandable browser. In this case, the image data of all the regions of the business screen may not be captured at the same frequency. The frequency at which image data of the visible region of the business screen is captured by the expandable browser and the frequency at which image data of the invisible region of the business screen is captured by the expandable browser are changed. For example, the frequency at which the image data of the visible region is captured is set to a frequency equal to or higher than the frequency at which the image data of the invisible region is captured. As an example of numerical values, if the frequency at which the image of the visible region is captured is set to 30 frames per second (fps), the frequency at which the image data of the invisible region is captured is set to a frequency equal to or lower than 30 fps. The frequency at which image data of a portion changed from the visible region to the invisible region due to a change in the display range is captured is set based on an update frequency measured when the portion was within the visible region, while frequencies at which image data of other portions of the invisible region is captured are set to the lowest value or set to, for example, 1 fps that is a fixed value.

Every time image data captured at the aforementioned frequencies is transmitted by the App server 30 to the screen transferring apparatus 20, the difference detecting unit 23 executes the following process. That is, when receiving image data from the App server 30, the difference detecting unit 23 reads, from the frame buffer 23a, image data at a position corresponding to the position of the received image data on the business screen. Then, the difference detecting unit 23 compares, for pixels, pixel values of the image data transmitted by the App server 30 with pixel values of the image data read from the frame buffer 23a and checks whether or not the pixel values of the image data transmitted by the App server 30 are equal to the pixel values of the image data read from the frame buffer 23a. As a result, the difference detecting unit 23 detects, as a difference, pixels whose pixel values are not equal to pixel values of the image data read from the frame buffer 23a. If the pixels are detected as the difference, the difference detecting unit 23 writes, over the image data received from the App server 30, the image data that is included in the business screen stored in the frame buffer 23a and is at the position corresponding to the position of the image data received from the App server 30 on the business screen, and the difference detecting unit 23 causes image data obtained by the overwriting to be stored in the frame buffer 23a. Thus, the aforementioned buffer management is achieved. After that, the difference detecting unit 23 executes labelling on the pixels detected as the difference on the business screen, forms BLOB (set of pixels) having the same label added thereto into a rectangular shape, and identifies a “differential region” from the business screen. Subsequently, the difference detecting unit 23 determines whether or not the differential region identified from the business screen is included in the display range set by the display range setting unit 22. If the differential region is included in the display range, the difference detecting unit 23 reads image data corresponding to the differential region from the frame buffer 23a, compresses the image data of the differential region by a predetermined compression scheme, and outputs coded data of the differential region to the image transmitting unit 24. If the differential region is not included in the display range, the difference detecting unit 23 compresses the image data of the differential region by the predetermined compression scheme and outputs the coded data of the differential region to the image transmitting unit 24 after transmitting the image data included in the display range. The compression of the image data of the differential region may be achieved by still image compression or by video image compression executed on the image data of the differential region if the image data is updated at a frequency equal to or higher than a threshold in a predetermined time period of, for example, 1 second, like the technique disclosed in Japanese Laid-open Patent Publication No. 2011-238014 or the like.

The screen transmitting unit 24 is processing unit that transmits image data of the business screen.

As an example, every time the difference detecting unit 23 outputs coded data of a differential region, the image transmitting unit 24 transmits the coded data of the differential region to the client terminal 10. In the transmission of the coded data of the differential region, the image transmitting unit 24 also transmits information identifying the position and size of the differential region on the business screen in order to cause the client terminal 10 to update a frame buffer included in the client terminal 10. For example, upper left corner's coordinates (x, y) included in the image data of the differential region and elements such as the width w and height h of the image data are transmitted together with the image data. The position and size may not be defined as described above and may be defined by another method or may be defined as coordinates of four corners of the region, for example.

The update frequency measuring unit 25 is a processing unit that measures the frequency at which the business screen is updated.

As an example, the update frequency measuring unit 25 measures the frequency at which the visible region of the business screen is updated and the frequency at which the invisible region of the business screen is updated. In the measurement of the update frequencies, a first update map to be used to manage frequencies at which the visible region is updated and a second update map to be used to manage frequencies at which the invisible region is updated are used as an example. In the first and second update maps, the numbers of times when the visible and invisible regions are updated within a time period corresponding to a predetermined number of frames that are a frame having the latest frame number and frames immediately before the frame having the latest frame number are managed as the update frequencies, or the numbers of times when the visible and invisible regions are updated within the time period corresponding to, for example, 30 frames are managed as the update frequencies.

For example, when the difference detecting unit 23 detects a differential region, the update frequency measuring unit 25 generates the first or second update map by measuring the frequency at which the visible or invisible region is updated. For example, the update frequency measuring unit 25 maps the differential region, which has been identified within the time period corresponding to the predetermined number of frames that are a frame having the latest frame number and frames immediately before the frame having the latest frame number, to the visible or invisible region divided into mesh elements. Thus, frequencies at which the mesh elements into which the visible or invisible region is divided are updated are obtained. Then, the update frequency measuring unit 25 synthesizes mesh elements updated at non-zero frequencies and adjacent to each other with each other to form rectangular regions and extracts, as “updated regions”, the regions updated at the non-zero frequencies and obtained by synthesizing the mesh elements with each other. Then, the update frequency measuring unit 25 extracts the largest value among update frequencies of mesh elements of each of the extracted updated regions and generates the first or second update map in which update frequencies whose representative values are the largest values are associated with the updated regions. Alternatively, the update frequency measuring unit 25 may calculate averages of the frequencies at which the mesh elements included in the extracted updated regions are updated, and the update frequency measuring unit 25 may set the averages as representative values for the updated regions and generate the first or second update map, Portions of the first and second update maps generated in the aforementioned manner may be updated due to the occurrence of the following event.

As an example, when the display range is changed, the update frequency measuring unit 25 updates the first and second update maps as follows. That is, if an entry that indicates an updated region changed from the visible region to the invisible region due to the change in the display range exists in the first update map, the update frequency measuring unit 25 migrates the entry from the first update map to the second update map and registers the entry in the second update map. Thus, the entry that indicates the updated region changed from the visible region to the invisible region due to the change in the display range is deleted from the first update map and registered in the second update map. The migration and the registration are executed in order to use an update frequency measured when the updated region was within the visible region as the frequency at which image data of the updated region within the invisible region is captured. In addition, if an entry that indicates an updated region changed from the invisible region to the visible region exists in the second update map, the update frequency measuring unit 25 resets an update frequency indicated in the entry to a predetermined value or 1 fps that is the lowest value.

As another example, if an entry that is included in the first update map and indicates a duplicate updated region and an entry that is included in the second update map and indicates the duplicate updated region exist, the update frequency measuring unit 25 deletes the entry included in the second update map and indicating the duplicate updated region.

As another example, if the determining unit 26 (described later) determines that an updated region indicated in the first update map is adjacent to an updated region indicated in the second update map, the update frequency measuring unit 25 updates the following update frequency. That is, the update frequency measuring unit 25 updates the update frequency associated to the updated region that is indicated in the second update map and adjacent to the updated region indicated in the first updated map to the same value as the frequency at which the updated region indicated in the first update map is updated.

The determining unit 26 is a processing unit that determines whether or not an updated region indicated in the first update map and an updated region indicated in the second update map are adjacent to each other.

As an example, when the display range is changed or if the display range is not changed within the time period corresponding to the predetermined number of frames or, for example, 30 frames or within 1 second after the notification of previous capture settings, the determining unit 26 executes the following process. That is, the determining unit 26 calculates coordinates of corners of updated regions for the first and second update maps. For example, if the position and size of an updated region are identified by elements such as coordinates (x, y) of an upper left corner of the updated region and the width w and height h of the updated region, the determining unit 26 may calculate coordinates (x+w, y) as the position of an upper right corner of the updated region, coordinates (x, y+h) as the position of a lower left corner of the updated region, and coordinates (x+w, y+h) as the position of a lower right corner of the updated region, After that, the determining unit 26 compares coordinates of corners of the updated region indicated in the first update map with coordinates of corners of the updated region indicated in the second update map. In this case, if coordinates of a corner of the updated region indicated in the first update map are the same as coordinates of a corner of the updated region indicated in the second update map, the determining unit 26 may determine that the updated regions are adjacent to each other at the boundary of the display range.

The setting notifying unit 27 is a processing unit that notifies the App server 30 of capture settings.

As an example, the setting notifying unit 27 uses the API for from an external, the process of capturing image data of the business screen stored in the drawing buffer of the expandable browser executed on the App server 30. When the API is used, the setting notifying unit 27 sets the frequency at which the image data is captured by the App server 30 from the drawing buffer, and the setting notifying unit 27 sets the position and size of the image data to be captured by the App server 30 from the drawing buffer and notifies the App server 30 of the set frequency, the set position, and the set size as capture settings. For example, the setting notifying unit 27 notifies the App server 30 of capturing settings including a capture frequency in a range of 0 fps to 30 fps and including coordinates (x, y) of an upper left corner of an updated region and the width w and height of the updated region as an example of a capture position and capture size of the updated region.

For example, capture settings for the visible region are notified to the App server 30 in the following manner. As an example of numerical values, 30 fps or the highest value is set as the frequency at which image data of the visible region is captured, coordinates (x, y) of the upper left corner of the display range and the width w and height h of the display range are set as the capture position and capture size of the visible region. The capture frequency, the capture position, and the capture size are notified as the capturing settings to the App server 30.

Capture settings for updated regions included in the invisible region and indicated in entries of the second update map are notified to the App server 30 for the entries in the following manner. As an example of numerical values, update frequencies of the updated regions are set as frequencies at which image data of the updated regions is captured, and coordinates (x, y) of upper left corners of the updated regions and the widths w and heights h of the updated regions are set as capture positions and capture sizes of the updated regions. The capture frequencies, the capture positions, and the capture sizes are notified as the capture settings to the App server 30.

When the display range is changed or if the display range is not changed within the predetermined time period of, for example, 1 second after the notification of previous capture settings, the notification of the capture settings is executed.

Configuration of App Server

Next, a functional configuration of the App server 30 according to the first embodiment is described. As illustrated in FIG. 1, the App server 30 includes an operational information receiving unit 32, a screen generating unit 33, a drawing buffer 34, and a capturing unit 35.

Processing units such as the operational information receiving unit 32, the screen generating unit 33, and the capturing unit 35 are implemented in the following manner. That is, the processing units are virtually achieved by causing the central processing unit or the CPU to load the aforementioned expandable browser 31 as a process into the work area of the RAM that has been implemented as the main storage device (not illustrated) and is a DRAM, an SRAM, or the like.

Although the case where a main unit for executing the expandable browser 31 is the CPU is described as an example, the main unit for executing the expandable browser 31 may not be the CPU and may be a processor of another type such as an MPU. In addition, the aforementioned functional units may be achieved by hardware logic such as an ASIC or an FPGA.

A semiconductor memory element such as a RAM may be implemented as a storage section such as the drawing buffer 34.

FIG. 1 selectively illustrates the minimal functional units related to the expandable browser 31. The App server 30 may include a certain functional unit other than the functional units illustrated in FIG. 1, while an existing computer includes the same functional units as the certain functional unit. For example, the App server 30 may include the same hardware as that included in the existing computer. The App server 30 may include a communication interface circuit such as an NIC, for example. In addition, the App server 30 may include a processing unit virtually achieved by another program that is an OS, middleware, or the like and is the same as that to be executed in a processor included in the existing computer. Although the general-purpose functional unit included in the existing computer is not illustrated, it goes without saying that the functional unit is effective to achieve the various processes and may be included in the App server 30.

The operational information receiving unit 32 is a processing unit that receives operational information.

As an example, every time the operational information receiving unit 32 receives operational information, from the screen transferring apparatus 20, the operational information receiving unit 32 outputs the operational information to the screen generating unit 33. For example, if the client terminal 10 is implemented as a mobile terminal having a touch panel, the operational information receiving unit 32 outputs, as the operational information, information indicating types of operations such as tap, double tap, flick, swipe, long tap, drag, pinch-in, and pinch-out operations and the amount of an operation among the operations to the screen generating unit 33. The output of the amount of the operation depends on the type of the operation.

The screen generating unit 33 is a processing unit that generates the business screen.

As an example, when the expandable browser 31 is activated, the screen generating unit 33 generates image data of a top page of the business screen and causes the image data of the top page of the business screen to be stored in the drawing buffer 34 that is used by the expandable browser 34 as the work area. After that, the screen generating unit 33 interprets the operational information output from the operational information receiving unit 32 and detects commands for graphical user interface components provided by the expandable browser 31 or detects, for example, commands for a tab operation, a pulldown menu operation, an operation of calling a web page to be linked, and the like. In accordance with the results of the detection, the screen generating unit 33 updates image data of the business screen and causes the image data of the business screen to be stored in the drawing buffer 34.

The capturing unit 35 is a processing unit that captures image data in accordance with capture settings.

As an example, the capturing unit 35 captures image data from the drawing buffer 34 at different frequencies for three types that are the visible region, updated regions included in the invisible region, and the other remaining regions that are included in the invisible region and are not the updated regions. In the example of the numerical values, image data corresponding to the visible region of the business screen and stored in the drawing buffer 34 is captured at a frequency of 30 fps. In the example of the numerical values, image data corresponding to the updated regions within the invisible region of the business screen and stored in the drawing buffer 34 is captured at a frequency equal to or nearly equal to an update frequency migrated from the first update map and registered in the second update map. In the example of the numerical values, image data corresponding to the remaining regions within the invisible region of the overall business screen and stored in the drawing buffer 34 is captured at a frequency of 1 fps. Every time the capturing is executed, the capturing unit 35 transmits image data captured from the drawing buffer 34 to the screen transferring apparatus 20.

### Example 1

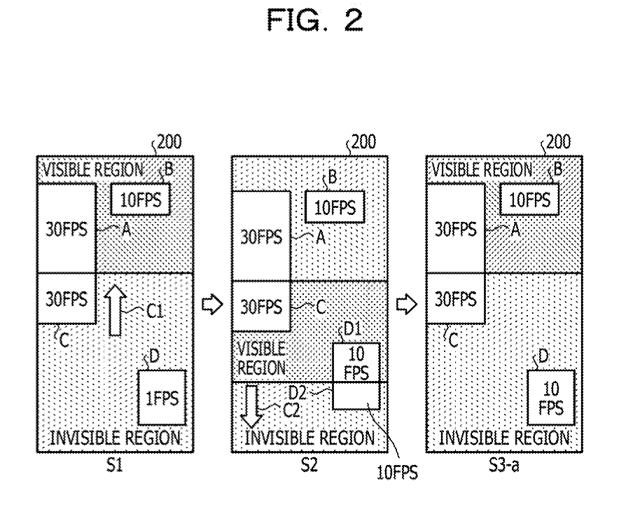

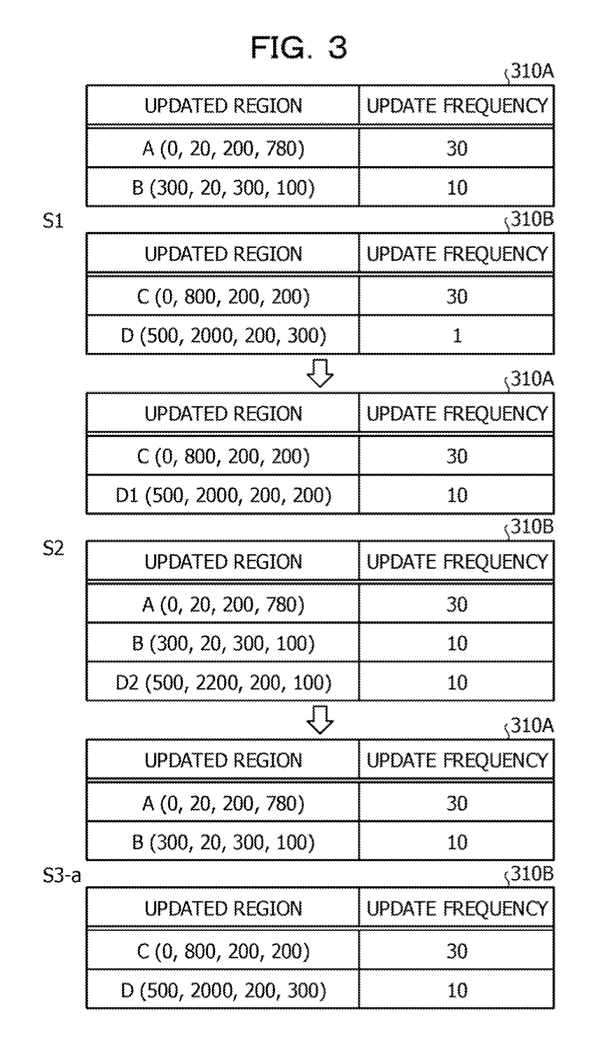

Next, an example of the screen transfer service is described. FIG. 2 illustrates an example of changes in the visible and invisible regions. FIG. 3 illustrates an example of changes in the update maps. In FIG. 2, a business screen 200 related to the same web page is illustrated, a visible region included in a display range of the business screen 200 is hatched, and an invisible region that is not included in the display range of the business screen 200 is hatched more lightly than the visible region. FIG. 3 illustrates first and second update maps generated in states indicated by S1, S2, and S3-a. In FIG. 3, upper tables in the states indicated by S1, S2, and S3-a indicate the first update map 310A, and lower tables in the states indicated by S1, S2, and S3-a indicate the second update map 310B. The numbers of the states S1, S2, and S3-a sequentially indicate elapsed time.

A left portion of FIG. 2 illustrates the visible and invisible regions in the state S1. In the state S1, the display range in which the client terminal 10 displays image data in the display of the client terminal 10 exists in a top portion of the business screen 200. The first and second update maps generated in the state S1 are illustrated in a top portion of FIG. 3. Specifically, the first entry of the first update map 310A from the top of the first update map 310A in the state S1 corresponds to an updated region A illustrated in the left portion of FIG. 2, while the second entry of the first update map 310A from, the top of the first update map 310A in the state S1 corresponds to an updated region B illustrated in the left portion of FIG. 2. In addition, the first entry of the second update map 310B from the top of the second update map 310B in the state S1 corresponds to an updated region C illustrated in the left portion of FIG. 2, while the second entry of the second update map 310B from the top of the second update map 310B in the state S1 corresponds to an updated region D illustrated in the left portion of FIG. 2. The updated regions A and C, which are among the updated regions A to D, are adjacent to each other at a boundary of the display range. In this case, an update frequency of the updated region C is set to the same value as the update frequency of “30 fps” of the updated region A.

In the aforementioned state S1, when a swipe operation C1 of swiping a finger or sliding a stylus pen upward on the touch panel of the client terminal 10 is performed, the display range of the business screen 200 is scrolled down. In this case, the state transitions from S1 to S2, and the visible and invisible regions are changed as illustrated in a central portion of FIG. 2. With the changes in the regions, the first and second update maps are changed as illustrated in a middle portion of FIG. 3. Specifically, entries of the updated regions A and B that were within the visible region in the state S1 are migrated from the first update map 310A to the second update map 3106 and registered in the second update map 310B. Thus, the entries of the updated regions A and B are generated as indicated in the second update map 310 illustrated in the middle portion of FIG. 3. The update frequency of “30 fps” measured when the updated region A was within the visible region is continuously set for the updated region A. The update frequency of “10 fps” measured when the updated region B was within the visible region is continuously set for the updated region B. The update frequency of the updated region C that was in the invisible region in the state S1, and an update frequency of a region D1 included in the updated region D that was in the invisible region in the state S1, are reset when the state transitions to S2 and the updated region C and the updated region D1 become regions within the visible region. After that, when the predetermined time period or 1 second corresponding to 30 frames elapses, the update frequency of the updated region C is re-measured to be 30 fps and the update frequency of the updated region D1 is re-measured to be 10 fps, as indicated in the first update map 310A illustrated in the middle portion of FIG. 3. A remaining updated region D2, which does not include the updated region D1 and is included in the updated region D that was in the visible region in the state S1, is adjacent to the updated region D1 at the boundary of the display range. Thus, the same frequency as the update frequency of “10 fps” of the updated region D1 is set for the updated region D2.

When the first update map 310A and the second update map 310B are generated, the screen transferring apparatus 20 notifies the App server 30 of the following capture settings. First, for the overall visible region including the updated regions C and D1, the highest capture frequency of 30 fps is set, the coordinates of the upper left corner of the display range are set to (0, 800) as a capture position, and the width and height of the display range are set to 720 and 800 as a capture size, respectively. Then, the capture frequency, the capture position, and the capture size are notified as capturing settings for the visible region to the App server 30. For the updated region A included in the invisible region, a capture frequency is set to 30 fps in accordance with the update frequency “30 fps”, indicated in the entry of the second, update map 310B, of the updated region A, coordinates of an upper left corner of the updated region A are set to (0, 20) as a capture position, and the width and height of the display range are set to 200 and 780 as a capture size, respectively. Then, the capture frequency, the capture position, and the capture size are notified as capturing settings for the updated region A to the App server 30. For the updated region B included in the invisible region, a capture frequency is set to 10 fps in accordance with the update frequency “10 fps”, indicated in the entry of the second update map 310B, of the updated region B, coordinates of an upper left corner of the updated region B are set to (300, 20) as a capture position, and the width and height of the display range are set to 300 and 100 as a capture size, respectively. Then, the capture frequency, the capture position, and the capture size are notified as capturing settings for the updated region B to the App server 30. For the updated region D2 included in the invisible region, a capture frequency is set to 10 fps in accordance with the update frequency “10 fps”, indicated in the entry of the second update map 310B, of the updated region D2, coordinates of an upper left corner of the updated region D2 are set to (500, 220) as a capture position, and the width and height of the display range are set to 200 and 100 as a capture size, respectively. Then, the capture frequency, the capture position, and the capture size are notified as capturing settings for the updated region D2 to the App server 30.

When image data of the invisible region is to be captured by the App server 30, image data of a region included in the invisible region and not including the updated regions A, B, and D2 is captured at the lowest frequency of 1 fps. Thus, the image data of the invisible region may be prepared for a change in the display range of the business screen, while the process load and the amount of data to be transferred may be suppressed.

When a swipe operation C2 of swiping a finger or sliding a stylus pen downward on the touch panel of the client terminal 10 is performed, the display range of the business screen 200 is scrolled up. In this case, the state transitions from S2 to S3-a, and the visible and invisible regions are changed as illustrated in a right portion of FIG. 2. Specifically, the display range is returned to the top portion of the business screen 200, and the updated regions A and B that were within the visible region in the state S2 are included in the visible region in the state S3-a again.

Regarding the updated regions A and B that are within the visible region in the state S3-a, when the updated regions A and B become regions within the invisible region in the state S2, capturing settings for the updated regions A and B are notified to the App server 30 in accordance with the second update map. Thus, image data of the updated region A is written in the frame buffer 23a from the App server 30 at the frequency of 30 fps, and image data of the updated region B is written in the frame buffer 23a from the App server 30 at the frequency of 10 fps. Thus, when image data of the visible region that is included in the display range upon the transition of the state from S2 to S3-a is displayed, the image data updated at the frequency of 30 fps is displayed in the updated region A included in the visible region in the display of the client terminal 10, and the image data updated at the frequency of 10 fps is displayed in the updated region B included in the visible region in the display of the client terminal 10. Thus, a reduction in the performance of a response to the swipe operation C2 may be suppressed.

After the state transitions from S2 to S3-a, the first and second update maps are changed as illustrated in a lower portion of FIG. 3. Specifically, entries of the updated regions C and D that were within the visible region in the state S2 are migrated from the first update map 310A to the second update map 310B and registered in the second update map 310B. Thus, an entry of the updated region C is generated and an entry of the updated region D is generated by synthesizing the updated regions D1 and D2 determined to be adjacent to each other at the boundary of the display range in the state S2, as indicated in the second update map 310B illustrated in the lower portion of FIG. 3. Although the case where the updated regions D1 and D2 are synthesized with each other is exemplified above, the updated regions D1 and D2 may not be synthesized and entries of the updated regions D1 and D2 may be separately generated. The update frequency of “30 fps” measured when the updated region C was within the visible region is continuously set for the updated region C, while the update frequency of “10 fps” measured when the updated region D was within the visible region is continuously set for the updated region D. The update frequencies of the updated regions A and B that were within the invisible region in the state S2 are reset when the state transitions to S3-a and the updated regions A and B become regions within the visible region, After that, when the predetermined time period or 1 second corresponding to, for example, 30 frames elapses, the update frequency of the updated region A is re-measured to be 30 fps and the update frequency of the updated region B is re-measured to be 10 fps, as indicated in the first update map 310A illustrated in the lower portion of FIG. 3.

In the state S3-a, the second update map illustrated in the lower portion of FIG. 3 is generated and the screen transferring apparatus 20 notifies the App server 30 of capture settings for the updated regions C and D in accordance with the update frequencies indicated in entries of the generated second update map. As a result, image data of the updated region C that is within the invisible region in the state S3-a is written in the frame buffer 23a from the App server 30 at the frequency of 30 fps, while image data of the updated region C that is within the invisible region in the state S3-a is written in the frame buffer 23a from the App server 30 at the frequency of 10 fps. Thus, the image data of the updated regions C and D within the invisible region may be prepared for a downward scroll operation that may be performed after the state S3-a.

### Example 2

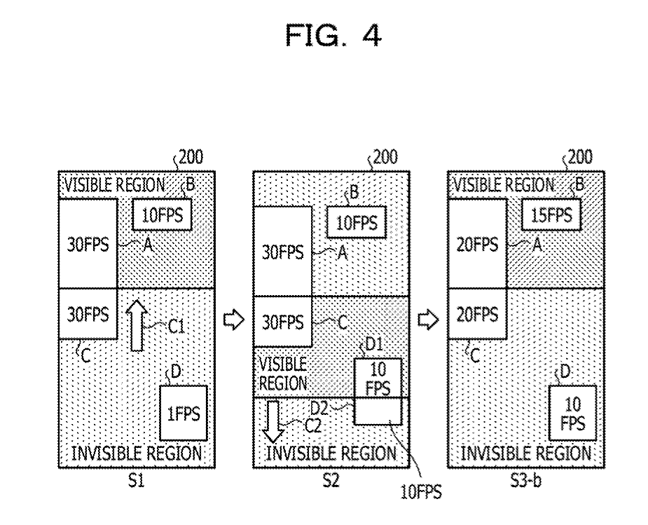

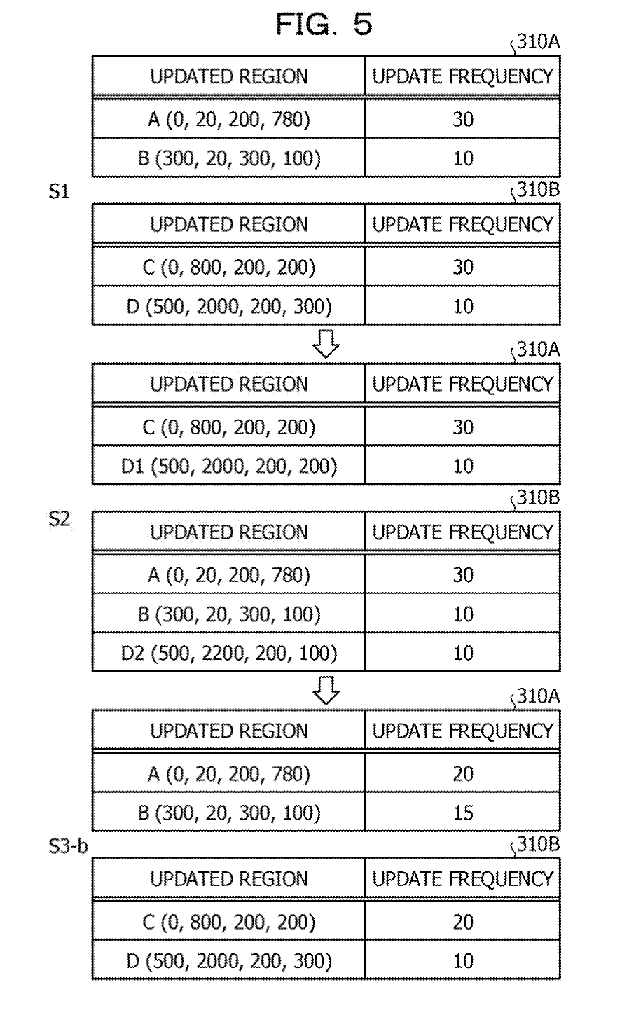

FIG. 4 illustrates an example of changes in the visible and invisible regions. FIG. 5 illustrates an example of changes in the update maps. FIG. 4 illustrates the business screen 200 related to the same web page. In FIG. 4, the visible region included in the display range of the business screen is hatched and the invisible region that is included in the business screen and is not included in the display range is hatched more lightly than the visible region. FIG. 5 illustrates the first and second update maps generated in states S1, S2, and S3-b illustrated in FIG. 4. In FIG. 5, upper tables in the states indicated by S1, S2, and S3-b indicate the first update map 310A, and lower tables in the states indicated by S1, S2, and S3-b indicate the second update map 310B. The numbers of the states S1, S2, and S3-b sequentially indicate elapsed time.

Details before the swipe operation C2 is performed or the state transitions from S2 to S3-b in the examples illustrated in FIGS. 4 and 5 are the same as the details before the swipe operation C2 is performed or the state transitions from S2 to S3-a in the examples illustrated in FIGS. 2 and 3. A state after the state 3-b is different from a state after the state 3-a, as described below. That is, when the state transitions to the state S3-b, and the updated regions A and B that were within the invisible region in the state S2 becomes regions within the visible region due to the transition to the state S3-b, the update frequencies of the updated regions A and B are reset. The update frequencies to be measured after the resetting are different from the update frequencies measured in the state S3-a illustrated in the examples of FIGS. 2 and 3. For example, when 1 second corresponding to 30 frames elapses, the update frequency of the updated region A is re-measured to be 20 fps and the update frequency of the updated region B is re-measured to be 15 fps, as indicated in the first update map illustrated in a lower portion of FIG. 5, As a result, the update frequency of the updated region C adjacent to the updated region A at the boundary of the display range is set to the same value as the update frequency of “20 fps” of the updated region A.

When a certain updated region that was within the visible region becomes a region within the invisible region and becomes a region within the visible region again, the update frequency of the certain updated region is reset and re-measured, and the update frequency, migrated from the first update map to the second update map and registered in the second update map, of the updated region may become close to the latest update frequency. When the certain updated region becomes a region within the visible region again, the update frequency may not be reset until being re-measured and a past value may be used as the update frequency of the certain updated region.

Flow of Process

Next, the flow of a process to be executed by the thin client system 1 according to the first embodiment is described. Hereinafter, (1) a process of transmitting image data by the screen transferring apparatus 20 and (2) a process of notifying the App server 30 of capture settings by the screen transferring apparatus 20 are described in this order.

(1) Process of Transmitting Image Data

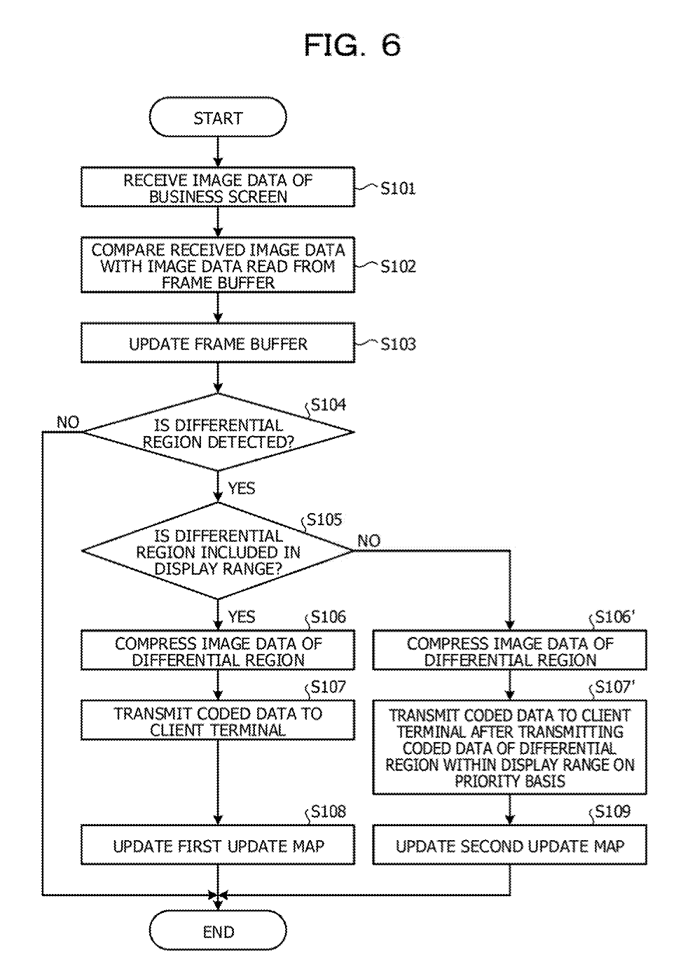

FIG. 6 is a flowchart indicating a procedure for the process of transmitting image data according to the first embodiment. This process is repeatedly executed at time intervals at which the expandable browser 31 executed in the processor of the App server 30 updates the drawing buffer 34 as an example. The time intervals are 30 fps, for example.

As illustrated in FIG. 6, when receiving, from the App server 30, image data of an updated region or the like within the visible or invisible region (in step S101), the difference detecting unit 23 reads, from the frame buffer 23a, image data at a position corresponding to the position of the image data received in step S101 and compares the image data received in step S101 with the image data read from the frame buffer 23a to check whether or not pixel values of the image data received in step S101 match pixel values of the image data read from the frame buffer 23a for pixels (in step S102).

Subsequently, the difference detecting unit 23 draws the image data received in step S101 at the position that is on the business screen stored in the frame buffer 23a and corresponds to the position of the image data received from the App server 30 and the difference detecting unit 23 updates the frame buffer 23a (in step S103).

After that, if a differential region is detected in step S102 (Yes in step S104), the difference detecting unit 23 determines whether or not the differential region identified from the business screen is included in the display range set by the display range setting unit 22 (in step S105).

If the differential region is included in the display range (Yes in step S105), the differential detecting unit 23 reads image data corresponding to the differential region from the frame buffer 23a and compresses the image data corresponding to the differential region by the predetermined compression scheme to generate coded data of the differential region (in step S106). Then, the image transmitting unit 24 transmits the coded data of the differential region to the client terminal 10 (in step S107). After that, the update frequency measuring unit 25 updates the first update map by incrementing an update frequency of a mesh element corresponding to the differential region and located in the visible region and indicated in the first update map (in step S108) and terminates the process.

On the other hand, if the differential region is not included in the display range (No in step S105), the difference detecting unit 23 reads, from the frame buffer 23a, image data corresponding to the differential region and compresses the image data corresponding to the differential region by the predetermined compression scheme to generate coded data of the differential region (in step S106′). Then, the image transmitting unit 24 transmits the coded data of the differential region to the client terminal 10 after transmitting coded data within the display range (in step S107′). After that, the update frequency measuring unit 25 updates the second update map by incrementing an update frequency of a mesh element corresponding to the differential region and located in the invisible region and indicated in the second update map (in step S109) and terminates the process.

(2) Process of Notifying of Capture Settings

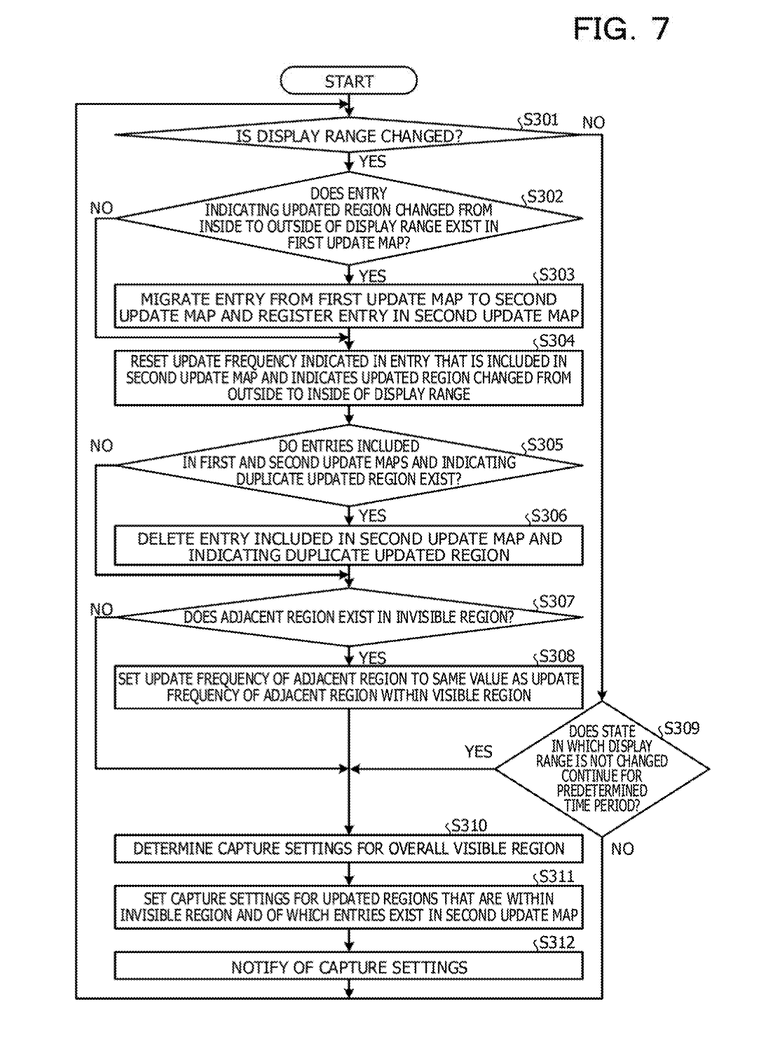

FIG. 7 is a flowchart indicating a procedure for the process of notifying of capture settings. This process is repeatedly executed at time intervals at which the expandable browser 31 executed in the processor of the App server 30 updates the drawing buffer 34 as an example. The time intervals are 30 fps, for example.

As illustrated in FIG. 7, when the display range is changed by the display range setting unit 22 (Yes in step S301), the update frequency measuring unit 25 determines whether or not an entry that indicates an updated region changed from the visible region to the invisible region due to the change in the display range exists in the first update map (in step S302), If the answer to the determination of step S302 is No, the process skips a process of step S303 and proceeds to a process of step S304.

In this case, if the entry that indicates the updated region changed from the visible region to the invisible region due to the change in the display range exists in the first update map (Yes in step S302), the update frequency measuring unit 25 migrates the entry from the first update map to the second update map and registers the entry in the second update map (in step S303).

Subsequently, the update frequency measuring unit 25 resets, to a predetermined value or, for example, 1 fps, an update frequency indicated in an entry that is included in the second update map and indicates an updated region changed from the invisible region to the visible region (in step S304).

After that, if an entry that is included in the first update map and indicates a duplicate updated region and an entry that is included in the second update map and indicates the duplicate updated region exist (Yes in step S305), the update frequency measuring unit 25 deletes the entry indicating the duplicate updated region from the second update map (in step S306). If the entry that is included in the first update map and indicates the duplicate updated region and the entry that is included in the second update map and indicates the duplicate updated region do not exist (No in step S305), the process skips the process of step S306 and proceeds to a process of step S302.

Then, the determining unit 26 determines whether or not updated regions that are indicated in the first and second update maps and adjacent to each other at the boundary of the display range exist (in step S307). If the updated regions that are indicated in the first and second update maps and adjacent to each other at the boundary of the display range exist (Yes in step S307), the update frequency measuring unit 25 executes the following process. That is, the update frequency measuring unit 25 updates an update frequency associated with the updated region indicated in the second update map and adjacent to the updated region indicated in the first update map to an update frequency of the updated region indicated in the first update map (in step S308). Then, the process proceeds to step S310. If the updated regions that are indicated in the first and second update maps and adjacent to each other at the boundary of the display range do not exist (No in step S307), the process skips the process of step S308 and proceeds to a process of step S310.

If the display range is not changed (No in step S301), the setting notifying unit 27 determines whether or not a state in which the display range is not changed continues for a predetermined time period of, for example, 1 second after the notification of previous capture settings (in step S309). If the state in which the display range is not changed continues for the predetermined time period (Yes in step S309), the process proceeds to step S310. If the state in which the display range is not changed does not continue for the predetermined time period (No in step S309), the process returns to step S301.

In step S310, the setting notifying unit 27 determines capturing settings for the visible region by setting the capture frequency of the visible region to the highest value of 30 fps and setting coordinates (x, y) of the upper left corner of the display range and the width w and height h of the display range as the capture position and capture size of the visible region. In addition, the setting notifying unit 27 determines capture settings for updated regions, which are within the invisible region and of which entries are included in the second update map, by setting update frequencies of the updated regions as capture frequencies of the updated regions and setting coordinates (x, y) of upper left corners of the updated regions and the widths w and heights h of the updated regions as capture positions and capture sizes of the updated regions (in step S311).

After that, the setting notifying unit 27 notifies the App server 30 of the capture settings determined in steps S310 and S311 (in step S312), and the process proceeds to the process of step S301.

Aspect of Effects

As described above, the screen transferring apparatus 20 according to the first embodiment sets a capture frequency of an updated region, which is currently within the invisible region of the business screen and has a history record indicating that the updated region was within the visible region, in accordance with an update frequency measured when the region was within the visible region. Thus, the size of a region included in the business screen and to be subjected to the capturing is reduced and the frequency at which the capturing is executed on the region is appropriately set. Thus, image data of the invisible region may be prepared for a change in the display range of the business screen, while the process load and the amount of data to be transferred may be suppressed. Thus, in the screen transferring apparatus 20 according to the first embodiment, a reduction in the performance of a response to a scroll operation may be suppressed.

### Second Embodiment

Although the embodiment related to the devices disclosed herein is described above, the present disclosure may include an embodiment other than the aforementioned embodiment. The other embodiment is described below.

Combined Use of RDP

The first embodiment describes the case where the screen transferring apparatus 20 acquires image data from the App server 30 by notifying the App server 30 of capture settings for both visible region included in the display range and invisible region that is not included in the display range, but the acquisition is not limited to this. For example, the expandable browser executed by the App server 30 may use OS support of hooking a draw command to be issued to the OS upon the update of the business screen and cause the App server 30 to transmit the draw command to the screen transferring apparatus 20. In this case, in the RDP, the draw command is acquired at a frequency of up to 15 fps or may be acquired at a frequency lower than the frequency at which the screen transferring apparatus 20 notifies the App server 30 of capture settings. Thus, when the first update map is to be updated by the screen transferring apparatus 20 in accordance with the draw command received from the App server 30, the screen transferring apparatus 20 may correct the frequency at which the draw command is acquired. For example, if the capture frequency is up to 30 fps and the frequency at which the draw command is acquired is up to 15 fps, the screen transferring apparatus 20 may correct the update frequency so that as the frequency at which the draw command is acquired becomes closer to zero, the corrected update frequency becomes even closer to zero and that as the update frequency measured in accordance with the draw command becomes closer to 15 fps, the corrected update frequency becomes even closer to the capture frequency of 30 fps.

Division and Integration

The constituent elements of the devices illustrated in the drawings may not be physically configured as illustrated in the drawings. Specifically, the specific forms of the division and integration of the devices are not limited to those illustrated in the drawings, and all or a part of the devices may be functionally or physically divided or integrated in an arbitrary unit based on loads and usage statuses of the devices. For example, a portion of processing units included in the operational information transferring unit 21, the display range setting unit 22, the difference detecting unit 23, the image transmitting unit 24, the update frequency measuring unit 25, the determining unit 26, and the setting notifying unit 27 may be coupled to the screen transferring apparatus 20 via a network and serve as an external device of the screen transferring apparatus 20. In addition, another device may have a portion of the processing units included in the operational information transferring unit 21, the display range setting unit 22, the difference detecting unit 23, the image transmitting unit 24, the update frequency measuring unit 25, the determining unit 26, and the setting notifying unit 27 and may be coupled to the screen transferring apparatus 20 via a network and collaborate with the screen transferring apparatus 20 so that the functions of the screen transferring apparatus 20 are achieved.

Screen Transfer Program

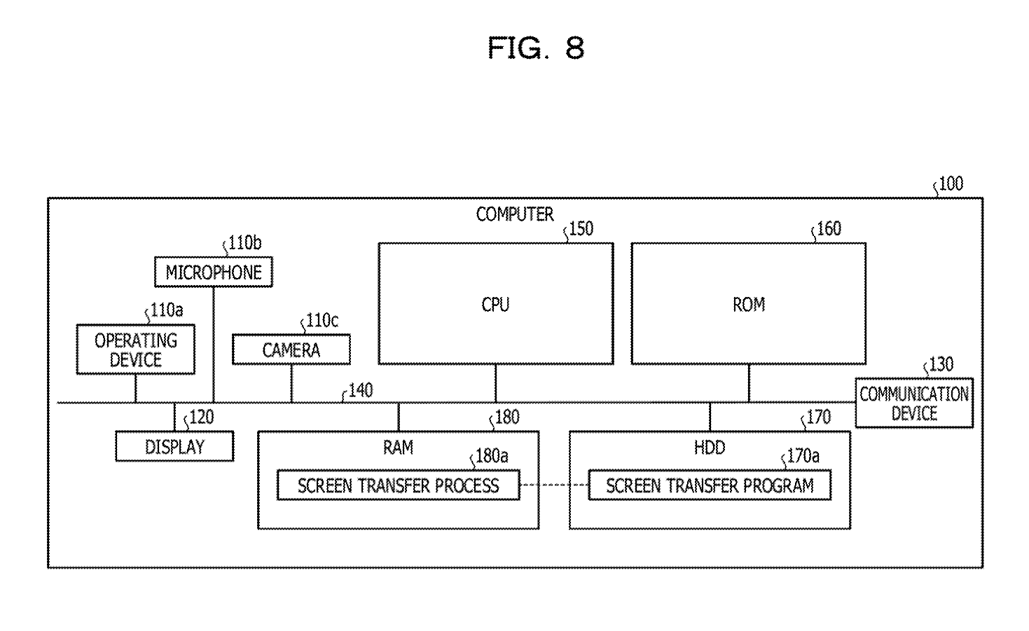

The various processes described in the first embodiment are achieved by causing a computer such as a personal computer or a workstation to execute the program prepared in advance. An example of the computer configured to execute the screen transfer program having the same functions as described in the first embodiment is described below with reference to FIG. 8.

FIG. 8 illustrates an example of a hardware configuration of the computer configured to execute the screen transfer program according to the first and second embodiments. As illustrated in FIG. 8, the computer 100 includes an operating device 110a, a microphone 110b, a camera 110c, a display 120, and a communication device 130. The computer 100 also includes a CPU 150, a ROM 160, an HDD 170, and a RAM 180. The units 110 to 180 are coupled to each other via a bus 140.

The screen transfer program 170a is stored in the HDD 170, as illustrated in FIG. 8. The screen transfer program 170a achieves the same functions as the operational information transferring unit 21, the display range setting unit 22, the difference detecting unit 23, the image transmitting unit 24, the update frequency measuring unit 25, the determining unit 26, and the setting notifying unit 27 that are described in the first embodiment. The screen transfer program 170a may be integrated or separated, like the constituent elements that are the operational information transferring unit 21, the display range setting unit 22, the difference detecting unit 23, the image transmitting unit 24, the update frequency measuring unit 25, the determining unit 26, and the setting notifying unit 27 and are illustrated in FIG. 1. Specifically all the data described in the first embodiment may not be stored in the HDD 170, and it is sufficient if data to be used for the processes is stared in the HDD 170.

In the aforementioned environment, the CPU 150 reads the screen transfer program 170a from the HDD 170 and loads the read screen transfer program 170a into the RAM 180. As a result, the screen transfer program 170a functions as a screen transfer process 180a, as illustrated in FIG. 8. The screen transfer process 180a loads data, read from the HDD 170, of various types into a storage region included in the RAM 180 and allocated to the screen transfer process 180a and executes the various processes using the loaded data of the various types. For example, the processes to be executed by the screen transfer process 180a include the processes illustrated in FIGS. 6 and 7. In the CPU 150, all the processing units described in the first embodiment may not operate. It is sufficient if processing units corresponding to the processes to be executed are virtually achieved in the CPU 150.

The screen transfer program 170a may not be initially stored in the HDD 170 or the ROM 160. For example, the screen transfer program 170a may be stored in a “portable physical medium” to be inserted in the computer 100. The portable physical medium is a flexible disk (FD), a CD-ROM, a DVD, a magneto-optical disc, an IC card, or the like. Then, the computer 100 may acquire the screen transfer program 170a from the portable physical medium and execute the screen transfer program 170a. In addition, the screen transfer program 170a may be stored in another computer, another server device, or the like that is coupled to the computer 100 via a public line, the Internet, a LAN, a WAN, or the like, and the computer 100 may acquire the screen transfer program 170a from the other computer, the other server device, or the like and execute the screen transfer program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
first setting a display range of image data stored in a memory and to be displayed in a display of a terminal device, in accordance with a scroll amount determined based on operational information acquired from the terminal device;
measuring a first frequency of update at which a region within the image data is updated in the display range; and
second setting, by a processor, based on the first frequency, a second frequency of capture at which partial image data of image data corresponding to the region is captured from the memory when the region is changed from an inside of the display range to an outside of the display range by changing of the display range.

2. The method according to claim 1, further comprising:
capturing the partial image from the memory at the second frequency set by the second setting.

3. The method according to claim 2, further comprising:
transmitting, to the terminal device, the captured partial image.

4. The method according to claim 1, further comprising:
determining whether or not a first region within the image data is adjacent at a boundary of the display range to a second region within the image data, the first region being changed from an inside of the display range to an outside of the display range when the display range is changed, the first frequency with regard to the second region being measured by the measuring,
wherein the second setting sets, based on the first frequency of the second region, the second frequency at which partial image data of the image data corresponding to the first region is captured from the memory when the determining determines that the first region and the second region are adjacent to each other at the boundary of the display range.

5. The method according to claim 1, further comprising:
transmitting, to the terminal device, image data obtained by hooking a draw command to be issued from an application to an operating system upon the update of a display screen of the terminal device.

6. An apparatus comprising:
a memory configured to store image data; and
a processor configured to:
set a display range of the image data in the memory and to be displayed in a display of a terminal device, in accordance with a scroll amount determined based on operational information acquired from the terminal device,
measure a first frequency of update at which a region within the image data is updated in the display range, and
set, based on the first frequency, a second frequency of capture at which partial image data of image data corresponding to the region is captured from the memory when the region is changed from an inside of the display range to an outside of the display range by changing of the display range.

7. The apparatus according to claim 6, wherein the processor is configured to:
capture the partial image from the memory at the set second frequency.

8. The apparatus according to claim 7, wherein the processor is configured to:
transmit, to the terminal device, the captured partial image.

9. The apparatus according to Maim 6, wherein the processor is configured to:
determine whether or not a first region within the image data is adjacent at a boundary of the display range to a second region within the image data, the first region being changed from an inside of the display range to an outside of the display range when the display range is changed, the first frequency with regard to the second region being measured, and
set, based on the first frequency of the second region, the second frequency at which partial image data of the image data corresponding to the first region is captured from the memory when the processor determines that the first region and the second region are adjacent to each other at the boundary of the display range.

10. The apparatus according to claim 6, wherein the processor is configured to:
transmit, to the terminal device, image data obtained by hooking a draw command to be issued from an application to an operating system upon the update of a display screen of the terminal device.

11. A non-transitory storage medium storing a program that causes a computer to execute a process, the process comprising:
first setting a display range of image data stored in a memory and to be displayed in a display of a terminal device, in accordance with a scroll amount determined based on operational information acquired from the terminal device;
measuring a first frequency of update at which a region within the image data is updated in the display range; and
second setting, based on the first frequency, a second frequency of capture at which partial image data of image data corresponding to the region is captured from the memory when the region is changed from an inside of the display range to an outside of the display range by changing of the display range.

12. The storage medium according to claim 11, wherein the process further comprises:
capturing the partial image from the memory at the second′frequency set by the second setting.

13. The storage medium according to claim 12, wherein the process further comprises:
transmitting, to the terminal device, the captured partial image.

14. The storage medium according to claim 11, wherein
the process further comprises:
determining whether or not a first region within the image data is adjacent at a boundary of the display range to a second region within the image data, the first region being changed from an inside of the display range to an outside of the display range when the display range is changed, the first frequency with regard to the second region being measured by the measuring, and
the second setting sets, based on the first frequency of the second region, the second frequency at which partial image data of the image data corresponding to the first region is captured from the memory when the determining determines that the first region and the second region are adjacent to each other at the boundary of the display range.

15. The storage medium according to claim 11, wherein the process further comprises:
transmitting, to the terminal device, image data obtained by hooking a draw command to be issued from an application to an operating system upon the update of a display screen of the terminal device.
